(19) United States
(12) Patent Application Publication
(10) Pub. No.: US 2023/0037235 A1
(43) Pub. Date: Feb. 2, 2023

(54) LIDAR APPARATUS AND PROCESS

(71) Applicant: VAI PHOTONICS PTY LTD, Australian Capital Territory (AU)

(72) Inventors: Lyle Edward ROBERTS, Australian Capital Territory (AU); James Thomas SPOLLARD, Australian Capital Territory (AU)

(73) Assignee: VAI PHOTONICS PTY LTD, Australian Capital Territory (AU)

(21) Appl. No.: 17/788,664

(22) PCT Filed: Dec. 23, 2020
(86) PCT No.: PCT/AU2020/051427

§ 371 Date: Jun. 23, 2022

(30) Foreign Application Priority Data
Dec. 23, 2019 (AU) 2019904904

(51) Int. Cl. G01S 7/4915; G01S 17/10; G01S 17/36

(52) U.S. Cl. CPC G01S 7/4915; G01S 17/10; G01S 17/36; G01S 17/58

(57) ABSTRACT

A LiDAR process executed by a signal processing component of a LiDAR apparatus, including: receiving LiDAR signal data representing a signal received at an optical receiver of a LiDAR apparatus and including a scattered and/or reflected portion of an optical signal transmitted by an optical transmitter of the LiDAR apparatus and encoded with a known digital signal, the scattered and/or reflected portion of the transmitted optical signal having been scattered and/or reflected from an object spaced from the LiDAR apparatus by a distance, and having a Doppler shifted angular frequency due to radial motion of the object relative to the LiDAR apparatus; processing the LiDAR signal data to generate corresponding frequency compensated signal data representing a frequency compensated signal corresponding to the received signal, but in which the Doppler shifted angular frequency has been removed and the known digital signal is encoded into the amplitude of the frequency compensated signal; and correlating the frequency compensated signal with a template of the known digital signal to generate a corresponding measurement of the distance of the object from the LiDAR apparatus.

### TECHNICAL FIELD

The present invention relates to LiDAR (Light detection and Ranging) technology, and in particular to a LiDAR apparatus and process for measuring distance and velocity.

### BACKGROUND

Most commercial LiDAR sensors use pulsed lasers to measure distance by timing how long it takes for a short pulse of light to scatter off a distant object and return to the sensor. Pulsed LiDAR has been sold commercially for decades due to its technological maturity, but suffers from several disadvantages in the context of autonomous vehicle applications. First, pulsed LiDAR sensors cannot measure velocity directly. Second, because they are sensitive to the intensity of the light they receive, they are highly susceptible to interference from other sources of light such as the sun and other LiDAR sensors. This susceptibility to interference also makes it difficult for them to perform consistently in the presence of dust, fog and snow, having a marked impact on reliability. Finally, pulsed LiDAR sensors do not readily adapt to dynamic operating conditions.

An emerging type of LiDAR technology, referred to as frequency modulated continuous wave (FMCW) LiDAR, aims to improve performance in autonomous vehicle applications by measuring more than just the intensity of the received light. In contrast to pulsed LiDAR, FMCW LiDAR is sensitive to both the intensity and the frequency of received light. This makes FMCW LiDAR sensitive to changes in frequency due to Doppler shifting of the scattered laser beam, enabling it to measure the radial velocity of an object relative to the sensor. Accordingly, FMCW LiDAR is capable of measuring range and velocity at the same time. But whilst the ability of FMCW sensors to measure velocity provides a distinct advantage over pulsed LiDAR sensors, they are still susceptible to interference from other LiDAR sensors. FMCW LiDAR is also more expensive than pulsed LiDAR due to the need for more sensitive, specialised optics and electronics.

It is desired to provide a LiDAR apparatus and process that alleviate one or more difficulties of the prior art, or to at least provide a useful alternative.

### SUMMARY

In accordance with the present invention, there is provided a LiDAR process executed by a signal processing component of a LiDAR apparatus, including:
receiving LiDAR signal data representing a signal received at an optical receiver of a LiDAR apparatus and including a scattered and/or reflected portion of an optical signal transmitted by an optical transmitter of the LiDAR apparatus and encoded with a known digital signal, the scattered and/or reflected portion of the transmitted optical signal having been scattered or reflected from an object spaced from the LiDAR apparatus by a distance, and having a Doppler shifted angular frequency due to motion of the object relative to the LiDAR apparatus;
processing the LiDAR signal data to generate corresponding frequency compensated signal data representing a frequency compensated signal corresponding to the received signal, but in which the Doppler shifted angular frequency has been removed and the known digital signal is encoded into the amplitude of the frequency compensated signal; and
correlating the frequency compensated signal with a template of the known digital signal to generate a corresponding measurement of the distance of the object from the LiDAR apparatus.

In some embodiments, the processing includes:
(i) processing the LiDAR signal data to generate corresponding second signal data representing a complex-conjugated and time-shifted copy of the received signal; and
(ii) processing the LiDAR signal data and the second signal data to generate the frequency compensated data by multiplying the received signal by the complex-conjugated and time-delayed copy of the received signal.

In some embodiments, the known digital signal is phase-encoded in the optical signal, and the Doppler-shifted portion of the optical signal is given by:

$$s [ n {T}_{s} ] = A {e}^{i ( ω n {T}_{s} + \frac{β}{2} c [ {nT}_{s} ] + θ [ {nT}_{s} ] )}$$

with amplitude A, angular frequency ω=2πf, time-varying phase θ[nTₛ], and c[nTₛ] is the known digital signal encoded in phase with modulation depth β;

the complex-conjugated and time-shifted copy of the received signal is given by:

$${s}^{*} [ ( n - K ) {T}_{s} ] = A {e}^{- i ( ω ( n - K ) {T}_{s} + \frac{β}{2} c [ ( n - K ) {T}_{s} ] + θ [ ( n - K ) {T}_{s} ] )}$$

where the time-delayed frequency ωKTₛ represents a constant phase shift, ϕ, relative to the unshifted signal s[n], and wherein the frequency compensated signal is given by:

q[nTₛ]=A²c[nTₛ]c[(n−K)Tₛ]·e^{iϕ}

In some embodiments, the known digital signal is a pseudo-random bit sequence, and the frequency compensated signal is given by:

q[nTₛ]=A²·c[nTₛ]·c[(n−K)Tₛ]·e^{iϕ}

In some embodiments, the process includes estimating the Doppler shifted angular frequency f_{d} according to:

$${f}_{d} = \frac{ϕ {F}_{s}}{2 R π K}$$

where Fₛ=1/Tₛ represents the sampling frequency used to generate the LiDAR signal data from the received optical signal.

In some embodiments, the known digital signal is amplitude-encoded in the optical signal, and the processing includes:
i) determining in-phase and quadrature components of the received signal; and
ii) determining the frequency compensated signal as a magnitude of a complex vector corresponding to the in-phase and quadrature components of the received signal.

In some embodiments, the process includes:
encoding an optical signal with the known digital signal;
causing an optical transmitter of the LiDAR apparatus to transmit the encoded optical signal towards the object; and
receiving the signal at an optical receiver of the LiDAR apparatus.

In accordance with some embodiments of the present invention, there is provided a LiDAR process, including:
receiving LiDAR signal data representing a signal received at an optical receiver of a LiDAR apparatus and including a scattered and/or reflected portion of an optical signal transmitted by an optical transmitter of the LiDAR apparatus and encoded with a known digital signal, the scattered and/or reflected portion of the transmitted optical signal having been scattered or reflected from an object spaced from the LiDAR apparatus by a distance, and having a Doppler shifted angular frequency due to motion of the object relative to the LiDAR apparatus;
processing the LiDAR signal data without dependence on the Doppler shifted angular frequency to generate corresponding frequency compensated signal data representing a frequency compensated signal corresponding to the received signal, but in which the Doppler shifted angular frequency has been removed and the known digital signal is encoded into the amplitude of the frequency compensated signal; and
correlating the frequency compensated signal with a template of the known digital signal to generate a corresponding measurement of the distance of the object from the LiDAR apparatus.

In accordance with some embodiments of the present invention, there is provided at least one computer-readable storage medium having stored thereon processor-executable instructions that, when executed by at least one processor of a LiDAR apparatus, cause the at least one processor to execute the process of any one of the above LiDAR processes.

In accordance with some embodiments of the present invention, there is provided at least one non-volatile storage medium having stored thereon Field Programmable Gate Array (FPGA) configuration data that, when used to configure an FPGA, causes the FPGA to execute the process of any one of the above LiDAR processes.

In accordance with some embodiments of the present invention, there is provided at least one non-volatile storage medium having stored thereon processor-executable instructions and FPGA configuration data that, when respectively executed by at least one processor of a LiDAR apparatus and used to configure an FPGA, causes the at least one processor and FPGA to execute the process of any one of the above LiDAR processes.

In accordance with some embodiments of the present invention, there is provided a LiDAR apparatus, including:
a laser to generate an optical signal;
an optical modulator to encode the optical signal with a known digital signal;
an optical transmitter to transmit the encoded optical signal towards an object spaced from the LiDAR apparatus by a distance;
an optical receiver to receive a signal including a portion of the transmitted optical signal scattered and/or reflected from the object, the scattered and/or reflected portion of the transmitted optical signal having a Doppler shifted angular frequency due to motion of the object relative to the LiDAR apparatus; and
a digital signal processor configured to execute the process of any one of the above LiDAR processes.

In accordance with some embodiments of the present invention, there is provided a LiDAR apparatus, including:
a laser to generate an optical signal;
an optical modulator to encode the optical signal with a known digital signal;
an optical transmitter to transmit the encoded optical signal towards an object spaced from the LiDAR apparatus by a distance;
an optical receiver to receive a signal including a portion of the transmitted optical signal scattered and/or reflected from the object, the scattered and/or reflected portion of the transmitted optical signal having a Doppler shifted angular frequency due to radial motion of the object relative to the LiDAR apparatus; and
a digital signal processing component configured to:
   receive LiDAR signal data representing the signal received by the optical receiver;
   process the LiDAR signal data to generate corresponding frequency compensated signal data representing a frequency compensated signal corresponding to the received signal, but in which the Doppler shifted angular frequency has been removed and the known digital signal is encoded into the amplitude of the frequency compensated signal; and
   correlate the frequency compensated signal with a template of the known digital signal to generate a corresponding measurement of the distance of the object from the LiDAR apparatus.

In some embodiments, the processing of the LiDAR signal data includes the steps of:
(i) processing the LiDAR signal data to generate corresponding second signal data representing a complex-conjugated and time-shifted copy of the received signal; and
(ii) processing the LiDAR signal data and the second signal data to generate the frequency compensated data by multiplying the received signal by the complex-conjugated and time-delayed copy of the received signal.

In some embodiments, the known digital signal is phase-encoded in the optical signal, and the Doppler-shifted portion of the optical signal is given by:

$$s [ n {T}_{s} ] = A {e}^{i ( ω n {T}_{s} + \frac{β}{2} c [ {nT}_{s} ] + θ [ {nT}_{s} ] )}$$

with amplitude A, angular frequency ω=2πf, time-varying phase θ[nTₛ], and c[nTₛ] is the known digital signal encoded in phase with modulation depth β;
the complex-conjugated and time-shifted copy of the received signal is given by;

$${s}^{*} [ ( n - K ) {T}_{s} ] = A {e}^{- i ( ω ( n - K ) {T}_{s} + \frac{β}{2} c [ ( n - K ) {T}_{s} ] + θ [ ( n - K ) {T}_{s} ] )}$$

where the time-delayed frequency ωKTₛ represents a constant phase shift, ϕ, relative to the unshifted signal s[n], and wherein the frequency compensated signal is given by:

q[nTₛ]=A²·c[nTₛ]·c[(n−K)Tₛ]·e^{iϕ}

In some embodiments, the known digital signal is a pseudo-random bit sequence, and the frequency compensated signal is given by:

q[nTₛ]=A²·c[(n−M)Tₛ]·e^{iϕ}

In some embodiments, the digital signal processing component is further configured to estimate the Doppler shifted angular frequency f_{d} according to:

f_{d}=ϕFₛ/2πRK
where Fₛ=1/Tₛ represents the sampling frequency used to generate the LiDAR signal data from the received optical signal.

In some embodiments, the known digital signal is amplitude-encoded in the optical signal, and the processing of the LiDAR signal data includes the steps of:
ii) determining in-phase and quadrature components of the received signal; and
iii) determining the frequency compensated signal as a magnitude of a complex vector corresponding to the in-phase and quadrature components of the received signal.

In some embodiments, the digital signal processing component is further configured to:
cause an optical signal to be encoded with the known digital signal; and cause the optical transmitter to transmit the encoded optical signal towards the object.

### BRIEF DESCRIPTION OF THE DRAWINGS

Some embodiments of the present invention are hereinafter described, by way of example only, with reference to the accompanying drawings, wherein:

FIGS. 1 to 5 are schematic diagrams of phase-encoded LiDAR apparatuses in accordance with respective embodiments of the present invention, respectively using:

FIG. 1: complex detection using a 90-degree optical coupler;

FIG. 2: time-separated in-phase/quadrature (I/Q) and Quadrature Phase Shift Keyed (QPSK) detection;

FIG. 3: complex detection using a 120-degree multi-mode interference optical coupler;

FIG. 4: polarization optics to act as an optical circulator; and

FIG. 5: a bi-static telescope;

FIG. 6 is a schematic diagram of a LiDAR process executed by a digital signal processor of the apparatus of FIGS. 1 to 5 to calculate time-of-flight with frequency compensation;

FIG. 7 is a schematic diagram of a LiDAR process executed by a digital signal processor of the apparatuses of FIGS. 2 to 5 to calculate the frequency of the input signal;

FIGS. 8 and 9 are graphs respectively showing raw and frequency compensated signals in accordance with the LiDAR process of FIG. 7, for a stationary object located 3.26 meters from a LiDAR sensor of the LiDAR apparatus;

FIGS. 10 and 11 are the same as FIGS. 8 and 9 but for an object moving at 2.5 meters per second and located 3.6 meters from the LiDAR sensor of the LiDAR apparatus;

FIG. 12 is a graph of the measured input signal frequency as a function of time, as determined by the process of FIG. 7;

FIGS. 13 and 14 are respective graphs of the frequency components of raw input signals and decoded input signals based on the computation of a cross-spectrum;

FIG. 15 is a schematic diagram of an amplitude-encoded LiDAR system with complex detection, in accordance with an embodiment of the present invention;

FIG. 16 is a schematic diagram of a LiDAR process executed by a digital signal processor of the apparatus of FIG. 15 to calculate time-of-flight with frequency compensation;

FIG. 17 is a block diagram of a signal processing component of the LiDAR apparatuses; and

FIG. 18 includes graphs illustrating the performance of an amplitude-encoded LiDAR process in accordance with an embodiment of the present invention.

### DETAILED DESCRIPTION

Embodiments of the present invention include LiDAR (Light Detection And Ranging) apparatuses and processes that are able to simultaneously and efficiently measure distance and velocity of remote objects, reducing the processing time required to execute safety-critical decisions in autonomous applications. The described LiDAR apparatuses and processes are also immune to interference from other LiDAR sensors operating nearby, which, in the case of autonomous vehicles, will become increasingly critical as the number of autonomous vehicles with LiDAR continues to grow.

The LiDAR apparatuses and processes described herein retain the advantages of existing FMCW systems, whilst providing improved immunity to crosstalk and interference, and the ability to simultaneously measure distance and velocity can be used to prioritise objects based on their movement to improve the safety and reliability of autonomous vehicles.

Optical Sub-System

Phase-Encoded LiDAR

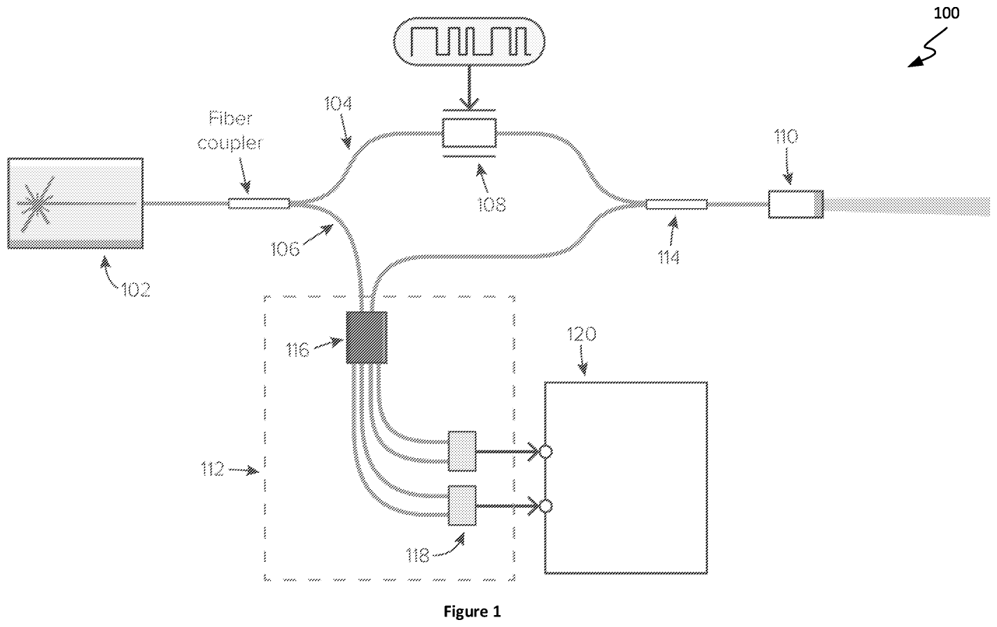

FIGS. 1 to 5 are schematic diagrams of respective embodiments of a LiDAR apparatus that uses phase-encoding of a digital signal. In the embodiment of FIG. 1, a laser 102 generates a coherent beam of light that is divided into two paths 104, 106. An electro-optic modulator (“EOM”) 108 is used to encode the phase of the outgoing light with a known digital signal. The resulting modulated light is transmitted from the LiDAR apparatus via a beam expander 110 to illuminate at least part of a remote object (not shown) which scatters and/or reflects a portion of the modulated light back towards an optical receiver 112 of the LiDAR apparatus. (For convenience of description, that portion of light is hereinafter described as being only “scattered” from the object, but the word “scattered” is to be understood broadly and in particular to encompass both scattering and reflection in their more strict technical senses.)

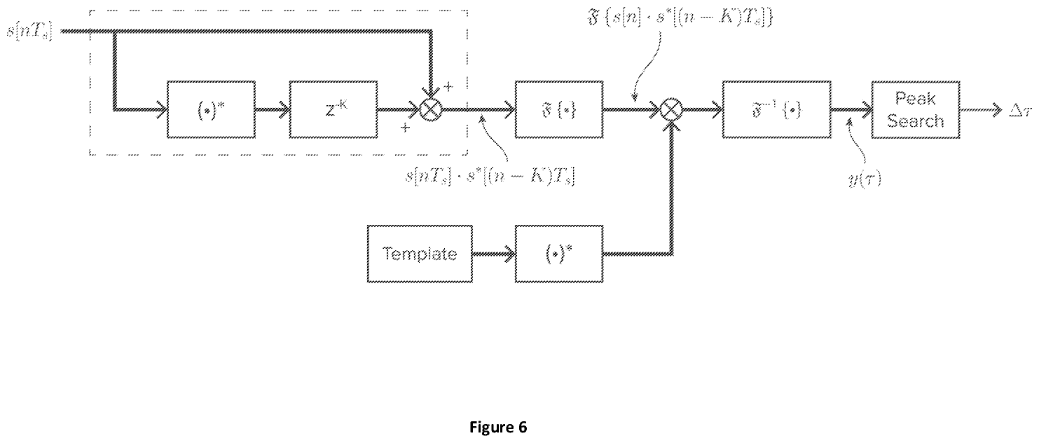

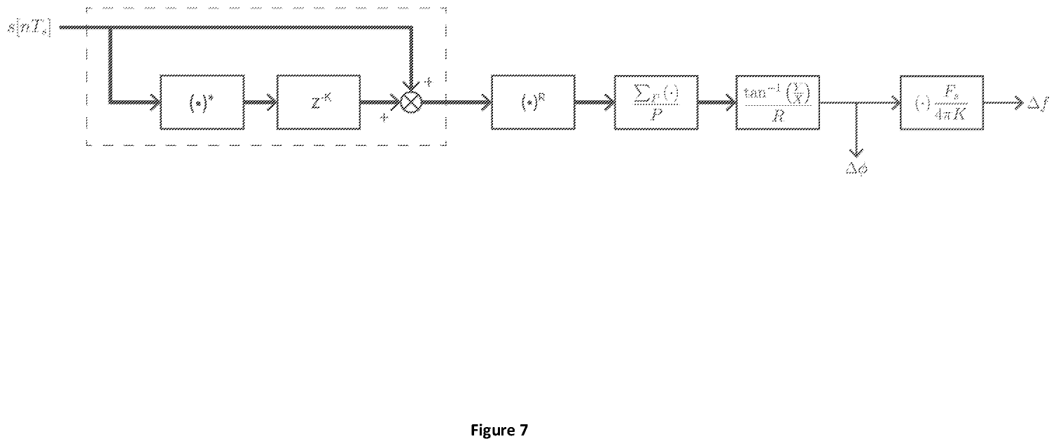

A small portion of the scattered light (an ‘echo’) is captured and coherently interfered with a local oscillator 106. In the described embodiments, the incoming light is separated from the outgoing light using a fibre optic circulator 114. In some embodiments, a fiber-optic polarization beam splitter is used in place of the fibre-optic circulator 114. The in-phase (I) and quadrature (Q) projections of the received optical signal with respect to the local oscillator are generated; for example, using a 90-degree optical coupler 116, as shown in FIG. 1. Two balanced photodetectors 118 are used to convert the electric fields produced by the 90-degree coupler 116 into voltage waveforms. The balanced photodetectors 118 also cancel common-mode noise. The voltage signals generated by the photodetectors 118 are discretely sampled using individual analog-to-digital converters (ADCs). The discrete-time signals generated by the ADCs are referred to collectively herein as LiDAR signal data, and are processed by the signal processing component 120 using digital signal processing, as shown in FIGS. 6 and 7 and described below.

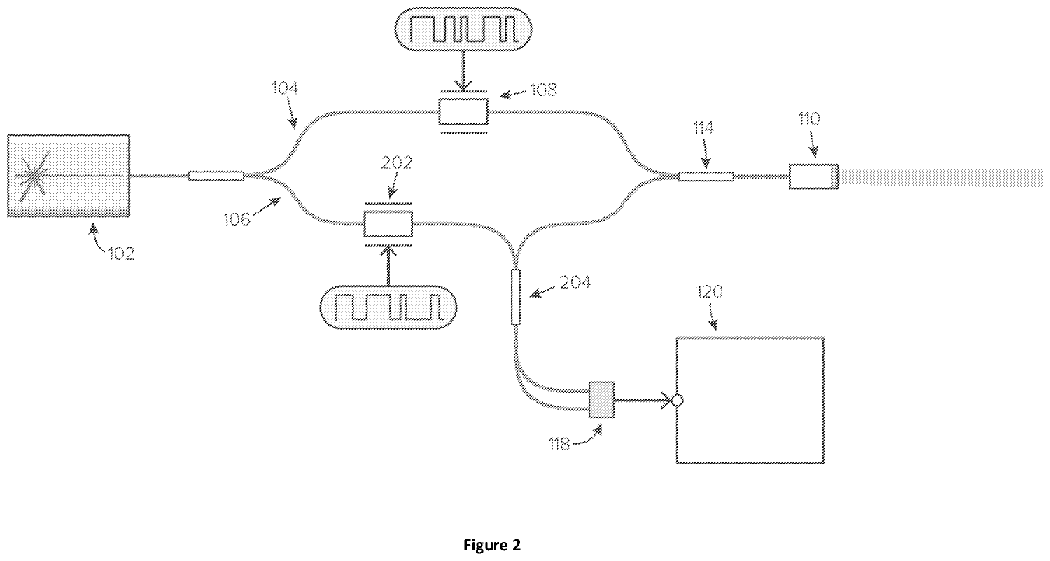

FIG. 2 is a schematic diagram of an alternative or ‘second’ embodiment, in which I and Q projections of the received optical signal are measured using a second electro-optic modulator 202 in the path of the local oscillator 106 to periodically shift its phase between 0 and −π/2 radians. Relative to the ‘first’ embodiment of FIG. 1, this embodiment transfers complexity from the optical system into digital signal processing by eliminating the need for a dedicated 90-degree complex coupler 116, instead replacing it with a fibre optic coupler 204 (e.g., in some embodiments a 3 dB coupler). In some embodiments, the periodic phase shift from 0 to −π/2 radians is combined with the digital signal modulated onto the phase of the outgoing light to produce a four-level QPSK code, eliminating the need for the second electro-optic modulator 202 in the path of the local oscillator altogether.

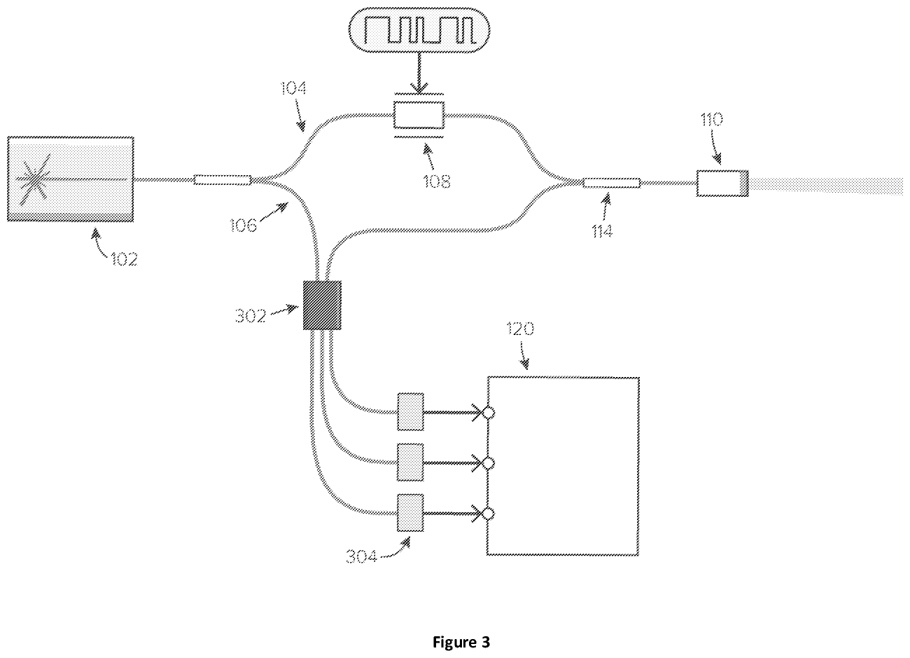

FIG. 3 is a schematic diagram of a third embodiment, in which a 120-degree multimode interference coupler 302 is used to generate three projections of the received optical signal relative to the local oscillator, each rotated 120-degrees relative to each other, and thus allowing I and Q to be reconstructed in signal processing. Photodetectors 304 are used to measure the interference of the received signal and local oscillator 106.

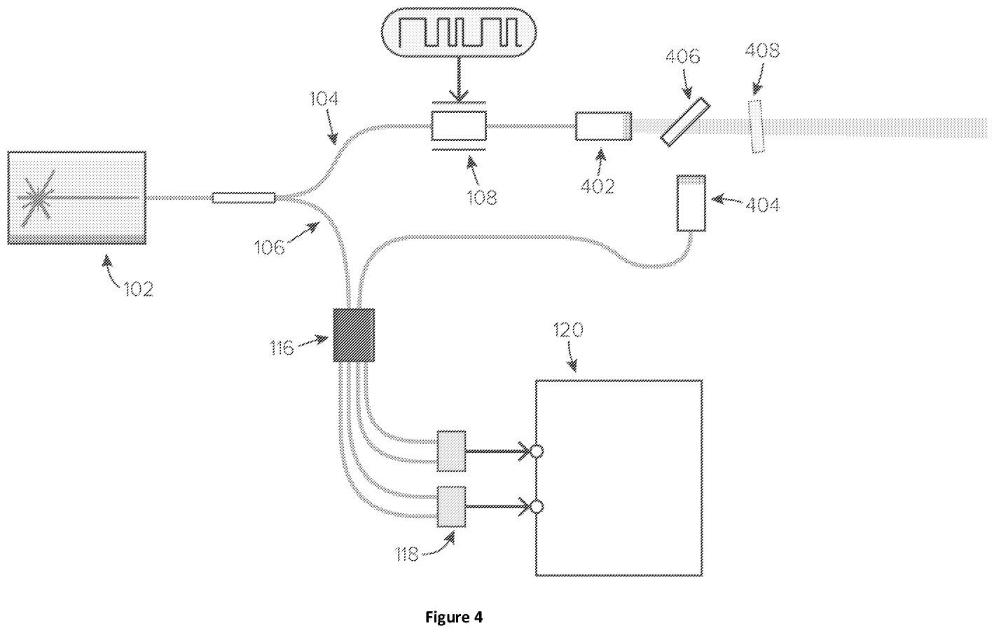

FIG. 4 is a schematic diagram of a fourth embodiment, in which two telescopes 402, 404, a polarizing beam splitter (PBS) 406, and quarter-wave plate 408 are used to create a free-space optical circulator in a bi-static arrangement with spatial mode overlap. This is done to prevent retro-reflected light due to internal scattering and Fresnel reflections from interfering with the measurement of the desired signal at the balanced photodetectors 118. In some embodiments, the quarter-wave plate 408 is angled slightly to prevent retro-reflected light from coupling back into the receiving telescope 404. In other embodiments, a partial reflector is placed beyond the quarter-wave plate 408 to generate a prompt back-reflection to serve as a reference for real-time range calibration.

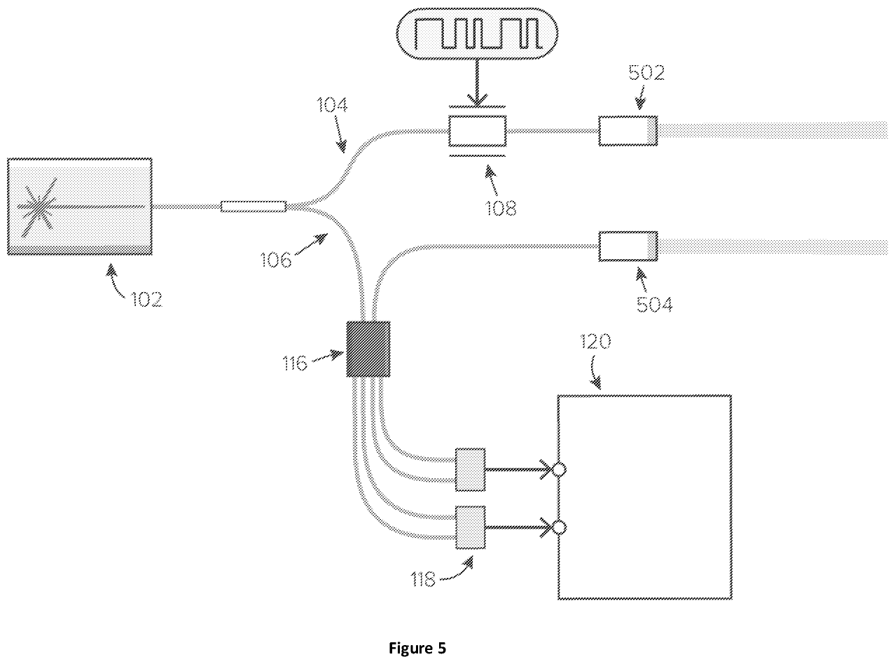

FIG. 5 is a schematic diagram of a fifth embodiment, in which two telescopes 502, 504 are positioned in close proximity to each other with spatially separated modes to provide improved immunity to interference caused by internal scattering and Fresnel reflections.

FIGS. 6 and 7 are block diagrams representing digital signal processing steps performed by the signal processing component 120 of the apparatuses of FIGS. 1 to 5. The signal processing component 120 executes a LiDAR process, as shown, that enables the simultaneous and independent measurement of an object's instantaneous distance and radial velocity (relative to the LiDAR apparatus). LiDAR requires a time-varying attribute of the light. For amplitude modulated LiDAR sensors, that attribute is intensity. For frequency modulated continuous wave (FMCW) LiDAR it is frequency. In phase-encoded LiDAR, the time varying attribute is phase. In some embodiments, the time-varying attribute is a known digital signal encoded into the phase of the transmitted light.

An object's radial movement relative to the LiDAR apparatus shifts the frequency of the light scattered by the object due to the Doppler effect, with the magnitude of the frequency shift being proportional to the relative radial velocity divided by the wavelength of the transmitted light. As an example, at a laser wavelength of 1550 nm, the Doppler frequency shift caused by a relative velocity of 50 km/h is approximately 18 MHz. The shorter the wavelength, the greater the relative frequency shift due to Doppler for a given radial velocity.

The Doppler shifting of the optical signal frequency poses a challenge because matched-template filtering is used to extract range information. As matched template-filtering relies on a correlation between the received signal and a local template, it is important to define the template as accurately as possible, which requires taking the Doppler shifting into account. This can be addressed by correlating the received signal with a range of different templates for respective different radial velocities. This technique works well in a post-processing or ‘offline’ context, when it is acceptable to compute a series of correlations over an extended period of time. However, for a LiDAR sensor to be useful in an automotive scenario, the signal processing must be capable of measuring range with low latency and with deterministic timing. Unfortunately, the signal processing resources needed to cover a sufficient two-dimensional (“2D”) correlation space over both Doppler frequency shift (velocity) and target delay (range) in real-time require a prohibitive amount of parallel signal processing resources. Implementing such brute force approaches in real-time requires extremely powerful processors, which are at this time not cost-effective for automotive LiDAR.

To address this difficulty, the inventors have developed LiDAR processes that avoid the computational burden of correlating the received signal with many templates by removing the (Doppler shifted) angular frequency from the received signal using a frequency compensation process of the LiDAR process, as described below, that is independent of the Doppler shifted angular frequency. To put it another way, as described below the frequency compensation process processes the received signal to generate a corresponding signal, referred to herein as a “frequency compensated” signal, which has no dependence on angular frequency (i.e., there is no angular frequency term in the expression for the frequency compensated signal), and the processing does not rely on, or have any knowledge of, the Doppler shifted angular frequency of the received signal.

The frequency compensation process determines in-phase and quadrature projections of the received optical signal, and uses them to generate a corresponding complex number. This can be achieved in several ways, including—but not limited to—using a 90-degree optical coupler, a 120-degree optical coupler, optical heterodyne detection, or a quadrature-phase shift keying encoding process, for example.

In the described phase-encoded LiDAR embodiments, the frequency compensation process begins by projecting the input signal to a single point within a stationary reference plane, as follows.

Let the input signal be defined as:

$$s [ n {T}_{s} ] = A {e}^{i ( ω n {T}_{s} + \frac{β}{2} c [ {nT}_{s} ] + θ [ {nT}_{s} ] )} \qquad ( 1 )$$

with amplitude A, angular frequency ω=2πf, time-varying phase θ[nTₛ], and a known digital signal c[nTₛ] encoded in phase with modulation depth β. The discrete time step, nTₛ, is represented by a discrete sample number n and a discrete time step (sampling period) Tₛ. The first step in the frequency compensation process is to generate a complex conjugated copy of the input signal delayed by K samples:

$${s}^{*} [ ( n - K ) {T}_{s} ] = A {e}^{- i ( ω ( n - K ) {T}_{s} + \frac{β}{2} c [ ( n - K ) {T}_{s} ] + θ [ ( n - K ) {T}_{s} ] )} \qquad ( 2 )$$

Assuming the angular frequency ω and phase are constant over the delay period K, Equation (2) can be rewritten as:

$$\begin{matrix}{s}^{*} [ ( n - K ) {T}_{s} ] = A {e}^{- i ( ω {nT}_{s} - ω {KT}_{s} + \frac{β}{2} c [ ( n - K ) {T}_{s} ] + θ )} \\ = A {e}^{- i ( ω n {T}_{s} - ϕ + \frac{β}{2} c [ ( n - K ) {T}_{s} ] + θ )}\end{matrix} \qquad ( 3 )$$

since the time-delayed frequency ωKTₛ represents a constant phase shift, ϕ, relative to the unshifted signal s[n]. If, for example, the modulation depth of the phase-encoded pattern is β=π (i.e., for a binary phase-shift keyed encoding scheme), then Equations (1) and (3) can be represented as:

s[nTₛ]=A·c[nTₛ]·e^{i(ωnT}^{ₛ}^{+θ)} (4)

and:

s*[(n−K)Tₛ]=A·c[(n−K)Tₛ]·e^{-i(ωnT}^{ₛ}^{-ϕ+θ)} (5)

respectively. The second step in the frequency compensation process is to multiply the unshifted input signal by the conjugated time-delayed copy, as follows:

$$\begin{matrix}q [ n {T}_{s} ] = s [ n {T}_{s} ] \cdot {s}^{⋆} [ ( n - K ) {T}_{s} = A \cdot c [ {nT}_{s} ] \cdot {e}^{i ( ω {nT}_{s} + θ )} \cdot A \cdot \\ c [ ( n - K ) {T}_{s} ] {e}^{- i ( ω {nT}_{s} - ϕ + θ )} \\ = {A}^{2} \cdot c [ {nT}_{s} ] \cdot c [ ( n - K ) {T}_{s} ] \cdot {e}^{i ϕ}\end{matrix} \qquad ( 6 )$$

Equation (6) demonstrates the removal of the angular frequency ω and phase θ from the input signal, whilst preserving information about the digital signal which now appears encoded into the amplitude of the resultant frequency compensated signal.

If the digital signal is a maximal-length sequence, then the multiplication of the digital signal with a time-delayed version of itself produces the same digital signal with a fixed sample delay, M, relative to the original digital signal:

q[nTₛ]=A²c[(n−M)Tₛ]·e^{iϕ} (7)

Correlating the frequency compensated signal of Equation (7) with a template of the original digital signal produces a measurement proportional to distance that can be compensated by the constant delay M.

The key advantage of the frequency compensation process is that it compensates the effects of Doppler shifting, enabling range to be calculated using a single template, and effectively collapsing a computationally intensive 2D search space into a single correlation calculation.

The frequency compensation process described herein also circumvents the need to measure and correct for a frequency shift on the received signal which, for example, could be accomplished by demodulating the input signal with a reference local oscillator prior to matched-template filtering.

The frequency compensation process also makes it possible to simultaneously estimate the Doppler frequency by recognising that the constant phase shift ϕ in q[nTₛ] is proportional to the total phase excursion due to Doppler shifting in the K sample time period, according to:

ϕ=f_{d}/Fₛ2πK

where Fₛ=1/Tₛ represents the signal sampling frequency. By measuring ϕ, it is therefore possible to estimate the Doppler frequency f_{d} according to:

f_{d}=ϕFₛ/2πK

To calculate ϕ, the digital signal c[(n−M)Tₛ] is removed. This can be done by raising q[nTₛ] to the power of R, where R represents the number of points in the phase-shift keying (PSK) constellation (e.g., R=2 for BPSK, and R=4 for QPSK):

$$\begin{matrix}{q [ n {T}_{s} ]}^{R} = {A}^{2 R} \cdot {c [ ( n - M ) {T}_{s} ]}^{R} \cdot {e}^{i R ϕ} \\ = {A}^{2 R} {e}^{i R ϕ}\end{matrix}$$

Applying Euler's formula, this result can be separated into its real and imaginary components, as follows:

e^{i2ϕ}=cos(Rϕ)+i sin(Rϕ)

allowing phase to be extracted using an inverse tangent function:

tan⁻¹(sin(Rϕ)/cos(Rϕ)=Rϕ

The Doppler frequency can then be calculated as:

f_{d}=ϕFₛ/2πRK (8)

This method of estimating Doppler frequency is, however, limited in the range of frequencies that it can unambiguously resolve, which is given by:

range(f_{d})=±Fₛ/2RK

Alternatively, the Doppler frequency can also be estimated via cross-spectral analysis of the raw input signal. To improve signal-to-noise ratio of the measured frequency, the raw input signal can be decoded with the digital signal at the correct delay that is measured by the matched-template correlation of the frequency compensated signal.

In summary, the LiDAR process described above for phase-encoded LiDAR collapses a computationally expensive 2D search space into two single 1D search spaces that can be executed simultaneously, improving computational efficiency so that LiDAR range and velocity information can be determined on lower cost, lower power consumption processing hardware.

Amplitude-Encoded LiDAR

The same improvements in computational efficiency can be achieved for amplitude-encoded LiDAR, in which a time-varying digital signal is encoded into the amplitude of the transmitted light. With a complex measurement of the received signal (e.g., using a 90-degree coupler), the effects of Doppler are removed by calculating the magnitude of the complex vector produced by the received signal's in-phase and quadrature components. Let the received input signal be:

s[nTₛ]=A·(1−αc[nTₛ])·e^{i(ωnT}^{ₛ}^{+θ)}

with amplitude A, angular frequency ω=2πf, phase θ, and a known digital signal c[nTₛ]∈[0,1] encoded in amplitude with modulation depth α∈[0,1].

The equation s[nTₛ] can be represented as:

s[nTₛ]=A·(1−αc[nTₛ])[cos(ωnTₛ+θ)+i sin(ωnTₛ+θ)]

The Doppler frequency shifts can be removed from the signal s[nTₛ] by summing the squares of its real and imaginary components, as follows:

Re[s[nTₛ]]²lm[s[nTₛ]]²=A²·(1−αc[nTₛ])²

Alternatively, multiplying s[nTₛ] by its complex conjugate is equivalent to calculating its magnitude squared:

s[nTₛ]·s*[nTₛ]=A²·(1−αc[nTₛ])²

The frequency compensated signal represents only the time-varying pattern which can be correlated with a single template to calculate distance. Velocity can be extracted via cross-spectral analysis of the original received signal by calculating, for example, the complex FFT (Fast Fourier Transform) of the input signal s[nTₛ], and finding the frequency of the highest magnitude peak in the FFT spectrum.

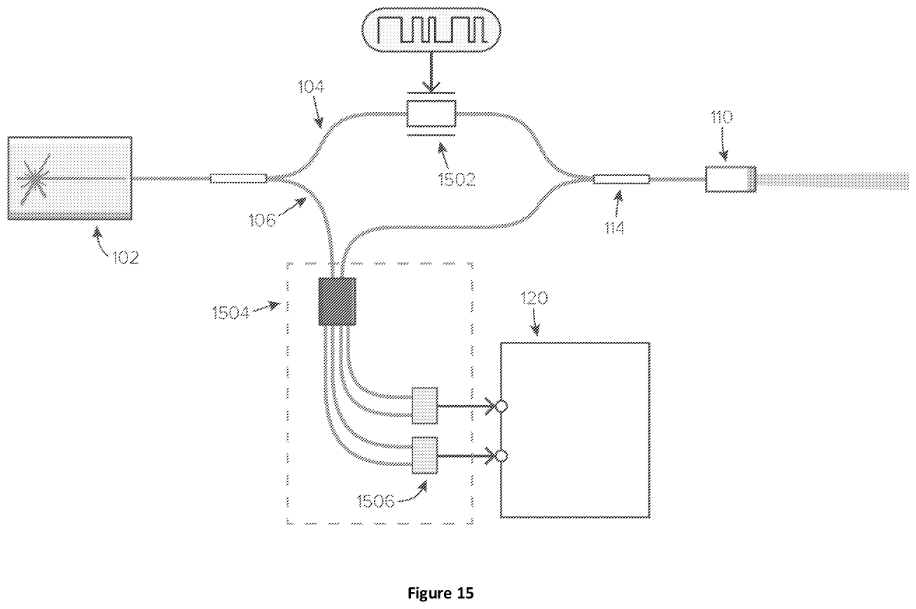

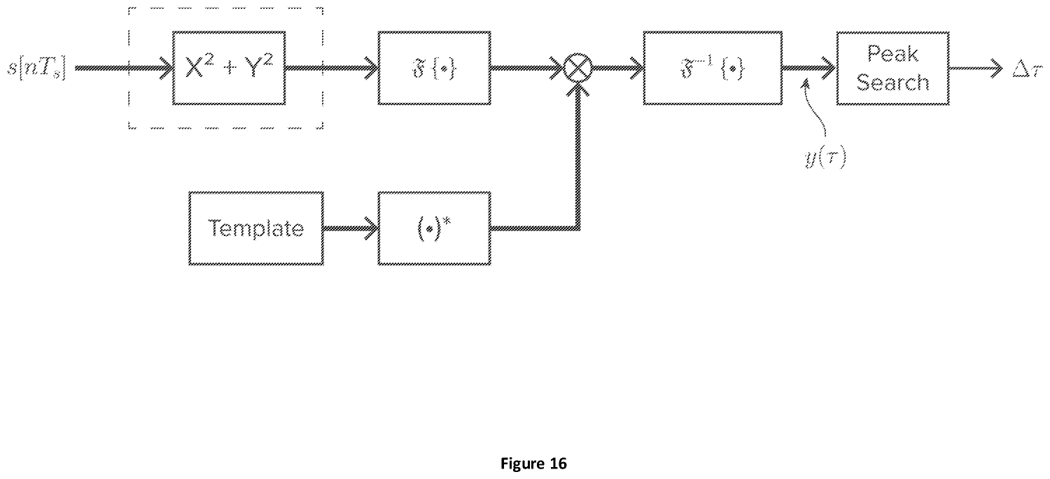

FIG. 15 illustrates an embodiment of the optical system of an amplitude-modulated LiDAR system. An electro-optic amplitude modulator 1502 is used to encode a digital signal onto the amplitude of the light. In the described embodiments, the electro-optic modulator 1502 is a Mach-Zehnder modulator with bias control. However, it will be apparent to those skilled in the art that the electro-optic amplitude modulator 1502 may be implemented by other types of modulator in other embodiments. A dual-quadrature detector 1504 is used to measure the in-phase and quadrature states of the received light relative to a reference local oscillator at two balanced photodetectors 1506.

Signal Processing Component (Electronic Sub-System)

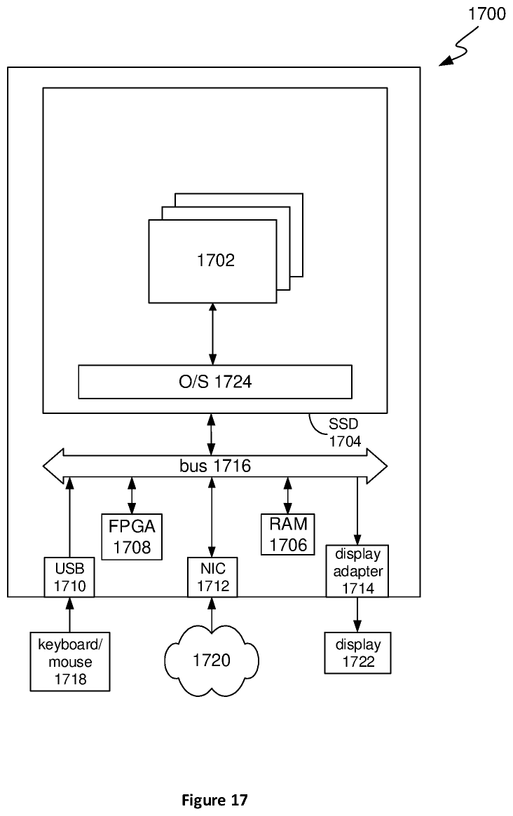

In the described embodiments, the LiDAR processes are implemented in the form of configuration data of a field-programmable gate array (FPGA) 1702 stored on a non-volatile storage medium 1704 such as a solid-state memory drive (SSD) or hard disk drive (HDD) of a signal processing component 1700 of the corresponding LiDAR apparatus, as shown in FIG. 17. However, it will be apparent to those skilled in the art that at least parts of the LiDAR processes can alternatively be implemented in other forms, for example as executable instructions of software components or modules executed by at least one microprocessor and/or by graphics processing units (GPUs), and/or as one or more dedicated hardware components, such as application-specific integrated circuits (ASICs), or any combination of these forms.

The signal processing component 1700 also includes random access memory (RAM) 1706, at least one FPGA (or processor, as the case may be) 1708, and external interfaces 1710, 1712, 1714, all interconnected by at least one bus 1716. The external interfaces may include a network interface connector (NIC) 1712 to connect the LiDAR apparatus to a communications network, and may include universal serial bus (USB) interfaces 1710, at least one of which may be connected to a keyboard 1718 and a pointing device such as a mouse 1719, and a display adapter 1714, which may be connected to a display device such as a panel display 1722. The signal processing component 1700 also includes an operating system 1724 such as Linux or Microsoft Windows.

### EXAMPLE

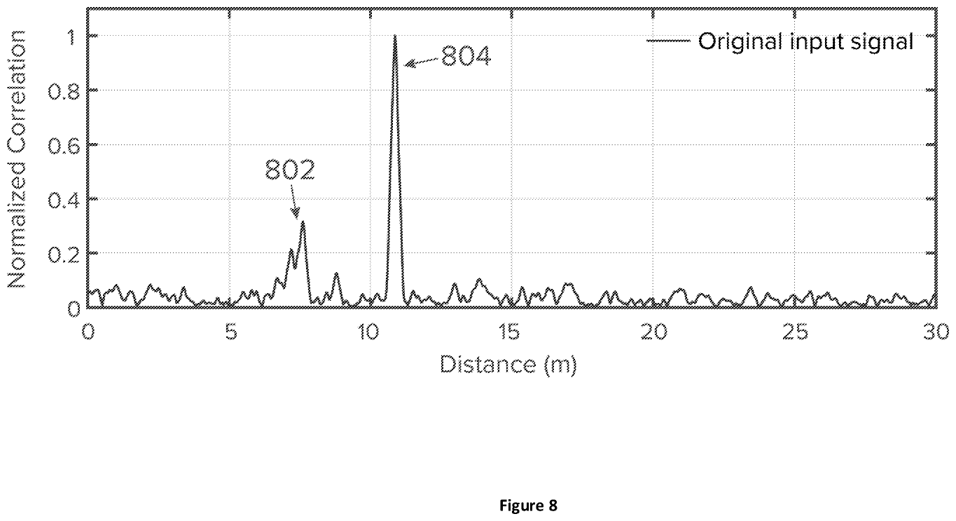

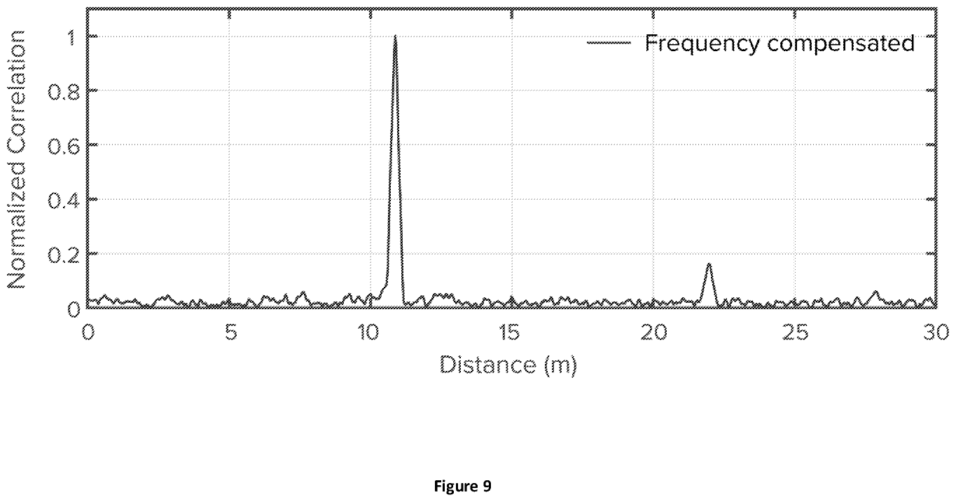

A phase-encoded LiDAR apparatus and process as described above and shown in FIG. 4 were applied to measure the range and relative radial velocities of an 80% reflective Lambertian surface, using two separate optical telescopes 402, 404 as the transmit and receiving optical elements in a bistatic configuration as shown in FIG. 4. FIGS. 8 and 9 illustrate the performance of the frequency compensation process when the object was stationary (i.e., with a relative velocity of 0 km/h) and located at an actual distance of 12.26 meters relative to the telescopes 402, 404. Specifically, FIGS. 8 and 9 respectively show matched template filtering results of the raw input signal with no Doppler cancellation processing, and with Doppler frequency compensation. Reflections 802 from the free-space circulator optics (i.e., polarizing beam splitter 406 and quarter-wave plate 408) are visible in FIG. 8 at an apparent range of 7.61 m. The echo 804 from the distant object is visible at an apparent range of 10.87 m. The prompt reflection 802 can serve as a reference from which to resolve the actual distance between the sensor and object (in this example 3.26 m), providing real-time calibration of range. FIG. 9 shows the same measurement with frequency compensation process applied. Because there is no Doppler component in this example due to the object being stationary, the result reveals a slight improvement in signal-to-noise ratio associated with the frequency compensation process which also compensates for correlated phase noise between the received in-phase and quadrature signals.

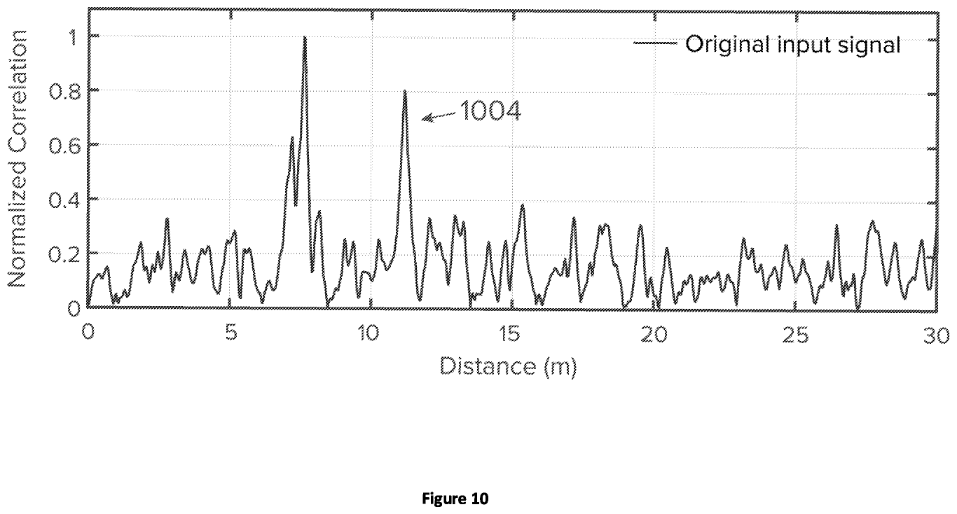

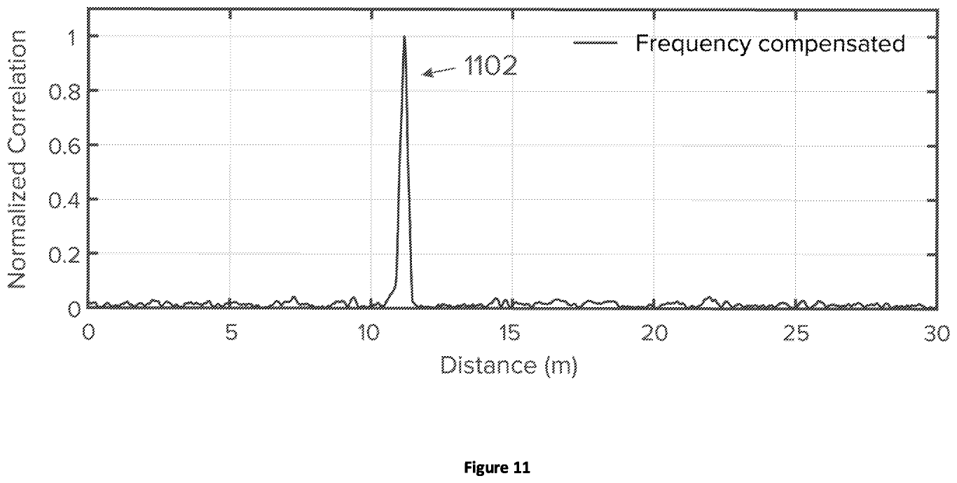

FIGS. 10 and 11 show corresponding matched template filtering results for the object moving at approximately 2.5 meters per second and located between 3 and 4 meters from the telescope 402 on a linear translation stage: a) without frequency compensation (FIG. 10); and b) with frequency compensation (FIG. 11). The prompt reflection from the free-space circulator optics is visible in FIG. 10 as a small peak 1002 located at an apparent range of 7.61 m. The echo 1004 from the moving object at a distance of approximately 3.6 m is barely visible because the matched filter does not take into account the echo's Doppler shift of 3.23 MHz. FIG. 11 shows the measurement of distance with frequency compensation. With frequency compensation, the range of the moving object can be resolved as a peak 1102 located at an apparent range of 11.17 meters, which when referenced to the prompt reflection peak 1002 at 7.61 meters corresponds to a self-calibrated range of 3.56 meters, which agrees with the estimated distance of the moving object at the point of measurement.

In a further example, an amplitude-encoded LiDAR apparatus and process as described above were applied to measure the range and frequency offset of a 40% reflective Lambertian surface using a single ‘mono-static’ telescope arrangement as shown in FIG. 1. The Lambertian target was located approximately 8.4 meters from the telescope. An optical circulator with a high return loss was used to minimise the magnitude of prompt reflections due to leakage through the circulator and Fresnel reflection from the end of the optical fibre and telescope optics.

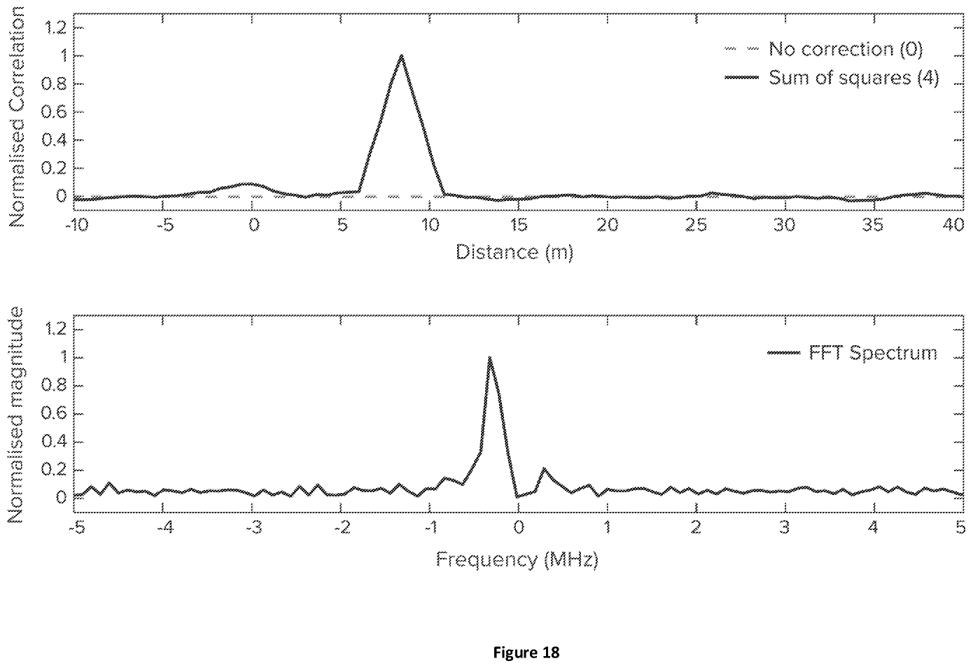

FIG. 18 illustrates the performance of the amplitude-encoded LiDAR sensor with a frequency offset of −158.48 kHz, successfully ranging to a 40% Lambertian surface located approximately 8.4 meters from the telescope. Prompt reflections caused by Fresnel reflections from the telescope optics and leakage through the optical circulator are visible as a small peak 1802 located at a distance of 0 meters. The target is clearly visible when the sum-of-squares frequency compensation technique described above is applied as shown in the top graph. Without the sum-of-squares frequency correction, the target distance is not resolved.

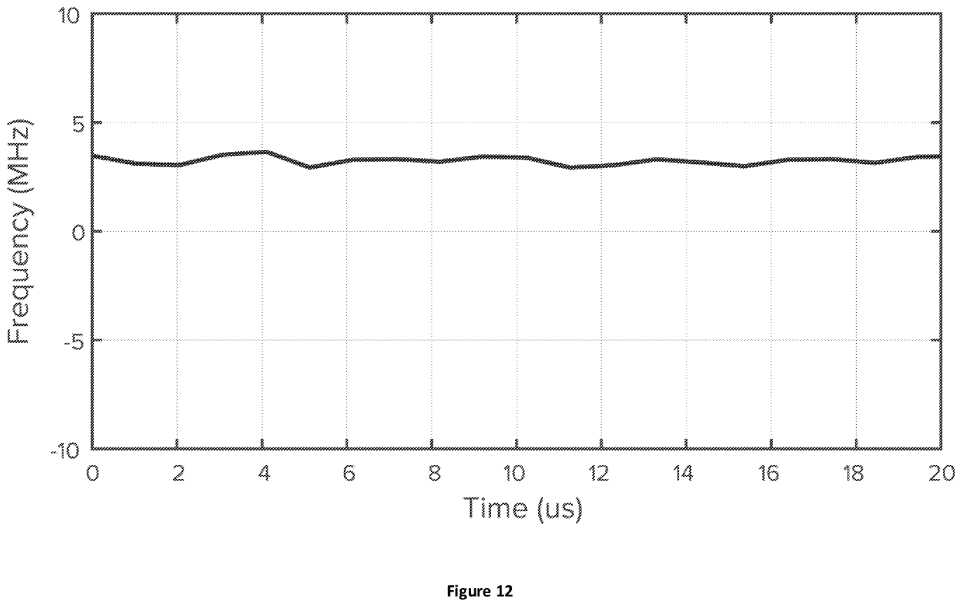

FIG. 12 shows the measurement of the input signal frequency using the frequency estimation process described in FIG. 7. The range of frequencies measured over a 10 us period was approximately 2.65 MHz to 3.7 MHz, corresponding to an estimated radial velocity in that 10 second period between 2.06 m/s and 2.86 m/s.

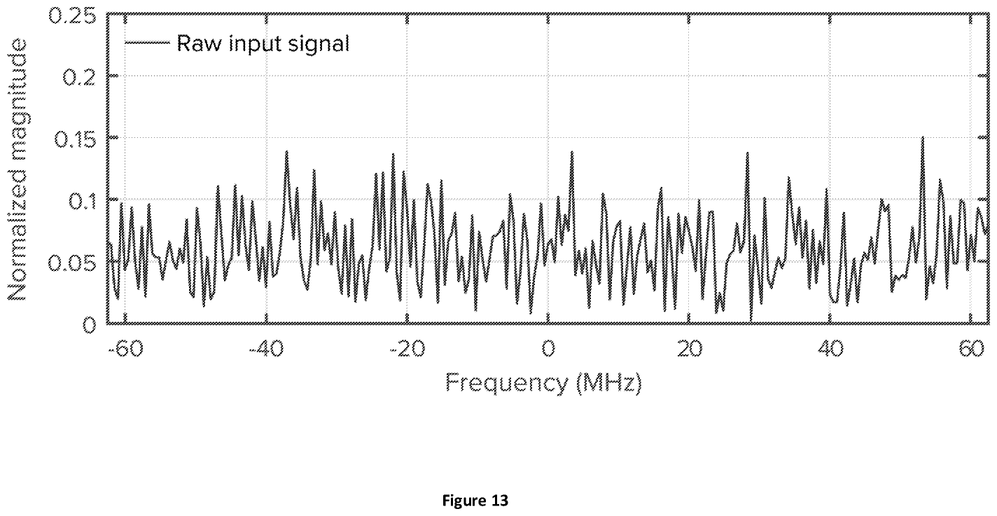

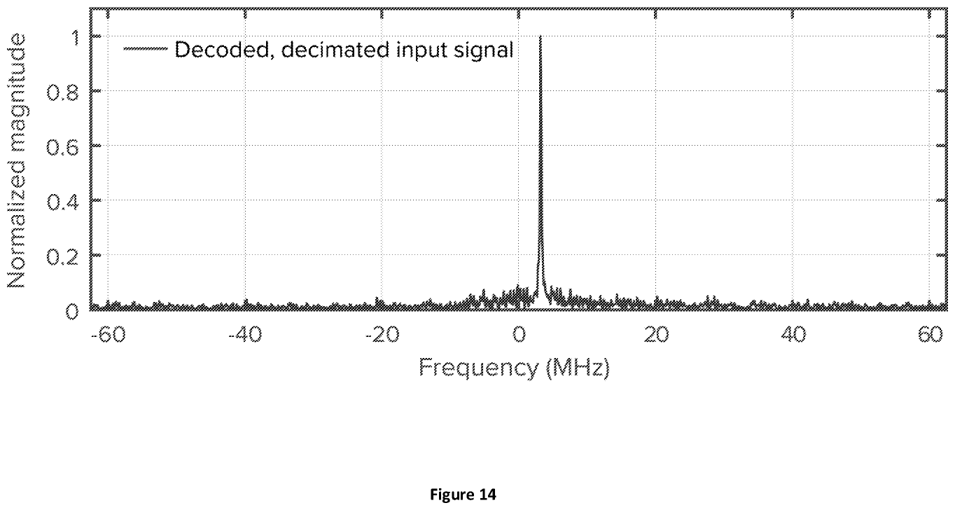

FIG. 13 shows the measurement of the input signal's frequency based on the computation of a cross-spectrum after decoding the raw input signal and decimating it using a decimating finite impulse response filter. The radial velocity of the object was measured to be 2.46 m/s.

Many modifications will be apparent to those skilled in the art without departing from the scope of the present invention.

1. A LiDAR process executed by a signal processing component of a LiDAR apparatus, including:
receiving LiDAR signal data representing a signal received at an optical receiver of a LiDAR apparatus and including a scattered and/or reflected portion of an optical signal transmitted by an optical transmitter of the LiDAR apparatus and encoded with a known digital signal, the scattered and/or reflected portion of the transmitted optical signal having been scattered and/or reflected from an object spaced from the LiDAR apparatus by a distance, and having a Doppler shifted angular frequency due to radial motion of the object relative to the LiDAR apparatus;
processing the LiDAR signal data to generate corresponding frequency compensated signal data representing a frequency compensated signal corresponding to the received signal, but in which the Doppler shifted angular frequency has been removed and the known digital signal is encoded into the amplitude of the frequency compensated signal; and
correlating the frequency compensated signal with a template of the known digital signal to generate a corresponding measurement of the distance of the object from the LiDAR apparatus; wherein the processing includes:
(i) processing the LiDAR signal data to generate corresponding second signal data representing a complex-conjugated and time-shifted copy of the received signal; and
(ii) processing the LiDAR signal data and the second signal data to generate the frequency compensated data by multiplying the received signal by the complex-conjugated and time-delayed copy of the received signal.

2. The process of claim 1, wherein the known digital signal is phase-encoded in the optical signal, and the Doppler-shifted portion of the optical signal is given by:
$$s [ n {T}_{s} ] = A {e}^{i ( ω n {T}_{s} + \frac{β}{2} c [ {nT}_{s} ] + θ [ n {T}_{s} ] )}$$
with amplitude A, angular frequency ω=2πf, time-varying phase θ[nTₛ], and c[nTₛ]is the known digital signal encoded in phase with modulation depth β;
the complex-conjugated and time-shifted copy of the received signal is given by:
$${s}^{*} [ ( n - K ) {T}_{s} ] = A {e}^{- i ( ω ( n - K ) {T}_{s} + \frac{β}{2} c [ ( n - K ) {T}_{s} ] + θ [ ( n - K ) {T}_{s} ] )}$$
where the time-delayed frequency ωKTₛ represents a constant phase shift, ϕ, relative to the unshifted signal s[n], and wherein the frequency compensated signal is given by:
q[nTₛ]=A²·c[nTₛ]·c[(n−K)Tₛ]·e^{iϕ}

3. The process of claim 2, wherein the known digital signal is a pseudo-random bit sequence, and the frequency compensated signal is given by:
q[nTₛ]=A²c[(n−M)Tₛ]·e^{iϕ}

4. The process of claim 2, including estimating the Doppler shifted angular frequency f_{d} according to:
f_{d}=ϕFₛ/2πRK
where Fₛ=1/T_{s J}represents the sampling frequency used to generate the LiDAR signal data from the received optical signal.

5. The process of claim 1, wherein the known digital signal is amplitude-encoded in the optical signal, and the processing includes:
ii) determining in-phase and quadrature components of the received signal; and
iii) determining the frequency compensated signal as a magnitude of a complex vector corresponding to the in-phase and quadrature components of the received signal.

6. The process of claim 1, including:
encoding an optical signal with the known digital signal;
causing an optical transmitter of the LiDAR apparatus to transmit the encoded optical signal towards the object; and
receiving the signal at an optical receiver of the LiDAR apparatus.

7. At least one computer-readable storage medium having stored thereon processor-executable instructions that, when executed by at least one processor of a LiDAR apparatus, cause the at least one processor to execute the process of claim 1.

8. At least one non-volatile storage medium having stored thereon FPGA configuration data that, when used to configure an FPGA, causes the FPGA to execute the process of claim 1.

9. At least one non-volatile storage medium having stored thereon processor-executable instructions and FPGA configuration data that, when respectively executed by at least one processor of a LiDAR apparatus and used to configure an FPGA, causes the at least one processor and FPGA to execute the process of claim 1.

10. A LiDAR apparatus, including:
a laser to generate an optical signal;
an optical modulator to encode the optical signal with a known digital signal;
an optical transmitter to transmit the encoded optical signal towards an object spaced from the LiDAR apparatus by a distance;
an optical receiver to receive a signal including a portion of the transmitted optical signal scattered and/or reflected from the object, the scattered and/or reflected portion of the transmitted optical signal having a Doppler shifted angular frequency due to motion of the object relative to the LiDAR apparatus; and
a digital signal processing component configured to execute the process of claim 1.

11. A LiDAR apparatus, including:
a laser to generate an optical signal;
an optical modulator to encode the optical signal with a known digital signal;
an optical transmitter to transmit the encoded optical signal towards an object spaced from the LiDAR apparatus by a distance;
an optical receiver to receive a signal including a portion of the transmitted optical signal scattered and/or reflected from the object, the scattered and/or reflected portion of the transmitted optical signal having a Doppler shifted angular frequency due to radial motion of the object relative to the LiDAR apparatus; and
a digital signal processing component configured to:
receive LiDAR signal data representing the signal received by the optical receiver;
process the LiDAR signal data to generate corresponding frequency compensated signal data representing a frequency compensated signal corresponding to the received signal, but in which the Doppler shifted angular frequency has been removed and the known digital signal is encoded into the amplitude of the frequency compensated signal; and
correlate the frequency compensated signal with a template of the known digital signal to generate a corresponding measurement of the distance of the object from the LiDAR apparatus; wherein the processing of the LiDAR signal data includes the steps of:
(i) processing the LiDAR signal data to generate corresponding second signal data representing a complex-conjugated and time-shifted copy of the received signal; and
(ii) processing the LiDAR signal data and the second signal data to generate the frequency compensated data by multiplying the received signal by the complex-conjugated and time-delayed copy of the received signal.

12. The apparatus of claim 11, wherein the known digital signal is phase-encoded in the optical signal, and the Doppler-shifted portion of the optical signal is given by:
$$s [ n {T}_{s} ] = A {e}^{i ( ω n {T}_{s} + \frac{β}{2} c [ {nT}_{s} ] + θ [ n {T}_{s} ] )}$$
with amplitude A, angular frequency ω=2πf, time-varying phase θ[nTₛ], and c[nTₛ] is the known digital signal encoded in phase with modulation depth β;
the complex-conjugated and time-shifted copy of the received signal is given by:
$${s}^{*} [ ( n - K ) {T}_{s} ] = A {e}^{- i ( ω ( n - K ) {T}_{s} + \frac{β}{2} c [ ( n - K ) {T}_{s} ] + θ [ ( n - K ) {T}_{s} ] )}$$
where the time-delayed frequency ωKTₛ represents a constant phase shift, ϕ, relative to the unshifted signal s[n], and wherein the frequency compensated signal is given by:
q[nTₛ]=A²·c[nTₛ]·c[(n−K)Tₛ]·e^{iϕ}

13. The apparatus of claim 12, wherein the known digital signal is a pseudo-random bit sequence, and the frequency compensated signal is given by:
q[nTₛ]=A²·c[(n−M)Tₛ]·e^{iϕ}

14. The apparatus of claim 12, wherein the digital signal processing component is further configured to estimate the Doppler shifted angular frequency f_{d} according to:
f_{d}=ϕFₛ/2πRK
where Fₛ=1/Tₛ represents the sampling frequency used to generate the LiDAR signal data from the received optical signal.

15. The apparatus of claim 11, wherein the known digital signal is amplitude-encoded in the optical signal, and the processing of the LiDAR signal data includes the steps of:
iv) determining in-phase and quadrature components of the received signal; and
v) determining the frequency compensated signal as a magnitude of a complex vector corresponding to the in-phase and quadrature components of the received signal.

16. The apparatus of claim 11, wherein the digital signal processing component is further configured to:
cause an optical signal to be encoded with the known digital signal; and
cause the optical transmitter to transmit the encoded optical signal towards the object.
